(19) United States
(12) Patent Application Publication
(10) Pub. No.: US 2014/0328719 A1
(43) Pub. Date: Nov. 6, 2014

(54) LEAD-FREE SOLDER COMPOSITION

(71) Applicant: Accurus Scientific Co., Ltd., Tainan City (TW)

(72) Inventor: Tien-Ting Chen, Tainan City (TW)

(73) Assignee: ACCURUS SCIENTIFIC CO., LTD., Tainan City (TW)

(21) Appl. No.: 14/059,167

(22) Filed: Oct. 21, 2013

(30) Foreign Application Priority Data
May 3, 2013 (TW) 102115886

(51) Int. Cl. B23K 35/26

(52) U.S. Cl. CPC B23K 35/262
USPC 420/561

(57) ABSTRACT

A lead-free solder composition includes: 3 wt % to 5 wt % of Ag, 0.2 wt % to 0.8 wt % of Cu, 1 wt % to 7 wt % of Bi, 0.005 wt % to 0.06 wt % of Ni, 0.005 wt % to 0.02 wt % of Ge, and the balance being Sn based on 100 wt % of the lead-free solder composition.

### CROSS-REFERENCE TO RELATED APPLICATION

This application claims priority of Taiwanese Application No. 102115886, filed on May 3, 2013.

### BACKGROUND OF THE INVENTION

1. Field of the Invention

This invention relates to a solder composition, more particularly to a lead-free solder composition adapted for use in soldering electronic components. 2. Description of the Related Art

In the prior art, a Sn—Pb alloy is usually used as a solder for electronic components. Owing to severe environmental pollution caused by lead and its compounds and increased environmental protection awareness, use of lead solders has been gradually forbidden in recent years. Hence, the lead solders are gradually being replaced by lead-free solders.

In a conventional non-wafer level packaging, wire bonding and underfill process are required. The size of a packaged product thus obtained is bigger than that of a die in the packaged product. Lead-free solder compositions may be formed into a solder bump to connect electronic components and a printed circuit board (referred as PCB) or a substrate. Thus, the solder bump is used as a binding agent and a spacer for the electronic components. The size and material strength of the solder bump are needed to be considered when the solder bump is used in the packaging process.

With the advancement of packaging techniques, a wafer level packaging (referred as WLP) has been developed. The wafer level packaging is the technology of packaging an integrated circuit at wafer level, and thus, the resulting packaged product is practically of the same size as a die. In wafer-level packaging, the wafer dicing step is carried out after all steps for forming a chip are conducted on the wafer. The size of a packaged chip formed by WLP is substantially the same as that of the original die so that WLP is also referred to as wafer level chip scale package (WLCSP).

Since a device formed by the wafer level packaging has a relatively small packaging size, the requirements for the size and strength of a solder bump are relatively strict. Moreover, the resistance to environmental change, i.e., change in temperature or humidity, for the solder bump is highly demanded.

### SUMMARY OF THE INVENTION

The object of the present invention is to provide a lead-free solder composition that has thermal resistance and that exhibits other desired properties.

According to this invention, there is provided a lead-free solder composition that includes 3 wt % to 5 wt % of Ag, 0.2 wt % to 0.8 wt % of Cu, 1 wt % to 7 wt % of Bi, 0.005 wt % to 0.06 wt % of Ni, 0.005 wt % to 0.02 wt % of Ge, and the balance being Sn based on 100 wt % of the lead-free solder composition.

### DETAILED DESCRIPTION OF THE PREFERRED EMBODIMENTS

The preferred embodiment of a lead-free solder composition according to this invention includes 3 wt % to 5 wt % of Ag, 0.2 wt % to 0.8 wt % of Cu, 1 wt % to 7 wt % of Bi, 0.005 wt % to 0.06 wt % of Ni, 0.005 wt % to 0.02 wt % of Ge, and the balance being Sn based on 100 wt % of the lead-free solder composition.

When the lead-free solder composition contains 3 wt % to 5 wt % of Ag, a tensile strength and solder hardness of the lead-free solder composition may be increased. However, when Ag content of the lead-free solder composition is above 5 wt %, a melting point of the lead-free solder composition is too high, limiting applications of the lead-free solder composition.

Cu is added in the lead-free solder composition to lower the melting point and to increase the strength of the lead-free solder composition. However, when Cu content is excess, the melting point of the lead-free solder composition would be raised. Hence, the Cu content preferably ranges from 0.2 wt % to 0.8 wt %.

Bi is added to improve the even distribution of Ag in the lead-free solder composition so as to avoid aggregation and generation of large particulates of intermetallic compound Ag₃Sn. Furthermore, the strength and hardness of the lead-free solder composition could be improved. Meanwhile, with the Bi element, when the lead-free solder composition is exposed to a high temperature for a long period of time, aggregation of Ag and Cu elements could be avoided and thus, large particles of intermetallic compound formed therefrom can be prevented, thereby eliminating cracks that extend along the intermetallic compound and failure in soldering connection. However, the excess Bi content would cause high brittleness and low toughness of the lead-free solder composition so that the solder bump formed from the lead-free solder composition would be liable to break. Therefore, the Bi content preferably ranges from 1 wt % to 7 wt %.

During the soldering process, the strength and hardness of the lead-free solder composition need to be maintained and the bonding strength between the solder bump of the lead-free solder composition and a PCB pad or a substrate needs to be considered. If a material of the PCB pad or the substrate is Cu, after exposing to a high temperature for a long time, a brittle Cu₃Sn intermetallic layer would be formed at an interface between the solder bump of the lead-free solder composition and the PCB pad or the substrate and may reduce the bonding strength between the solder bump and the PCB pad or the substrate. In this invention, a proper amount of Ni is added to facilitate generation of a Cu₆Sn intermetallic layer which has better bonding strength. Thus, generation of the Cu₃Sn intermetallic layer maybe prevented, thereby improving bonding strength. Moreover, generation of the Cu₃Sn intermetallic layer formed from Cu and Sn elements in the lead-free solder composition may also be inhibited. However, the excess Ni content is difficult to be evenly added in the lead-free solder composition, and oversaturation and precipitation of Ni may occur. Therefore, brittleness of the lead-free solder composition may increase and weaken the strength and the hardness of the lead-free solder composition. Accordingly, the Ni content preferably ranges from 0.005 wt % to 0.06 wt %.

Since the lead-free solder composition is easy to be oxidized at a high temperature, an anti-oxidative element, Ge, has to be added to avoid oxidation which would weaken the bonding strength. When Ge content is too low, the lead-free solder composition has little or inferior anti-oxidative activity. When Ge content is larger than 0.02 wt %, the bonding strength between the lead-free solder composition and the PCB pad or the substrate would become inferior. Consequently, the Ge content preferably ranges from 0.005 wt % to 0.02 wt %.

In view of the aforesaid, Cu, Bi, Ag, Ni, and Ge have to be simultaneously added to Sn to provide good thermal resistance and desired tensile strength and bonding strength, to avoid breaking and separation of the solder bump and the PCB pad or the substrate, and to avoid oxidation. Thus, the lead-free solder composition according to this invention could be used in wafer level packaging.

### EXAMPLES

### Preparation of Solder Compositions for Examples 1 to 13 and Comparative Examples 1 to 10

Solder compositions for Examples 1 to 13 and Comparative Examples 1 to 10 were prepared by mixing the components listed in Tables 1 to 5.

Effects of the present invention were proven by determining a tensile strength, a bonding strength, and anti-oxidative activity.

### Evaluation Methods

1. The tensile strength was measured using a Vickers Pyramid Diamond Indenter with application of 50 gw load for 15 seconds. To measure the tensile strength, a solder bump of the solder composition was formed on a copper pad by reflow soldering. The solder bump was cut to form a cutting surface and the measurement was conducted on the cutting surface using the Vickers Pyramid Diamond Indenter. An indentation formed on the cutting surface of the solder bump was measured so as to calculate the microhardness (Hv). The tensile strength was determined according to a standard as follows:
◯: microhardness>20 Hv;
Δ: 15 Hv<microhardness≦20 Hv; and
×: microhardness≦15 Hv.

The tensile strength was also measured after the solder composition was exposed at 150° C. for 7 days (hereinafter referred to as thermal treatment). The tensile strength after the aforesaid thermal treatment was determined according to a standard as follows:
◯: microhardness>16 Hv;
Δ: 11 Hv<microhardness≦16 Hv; and
×: microhardness≦11 Hv.

2. Anti-oxidative activity was determined by heating the solder composition for 30 minutes at 200° C. with ventilation of atmospheric air in an oven, and observing the change of brightness on a surface of a solder article formed from the solder composition. To be specific, the anti-oxidative activity was determined by the resistance to color change based on a standard as follows:
◯: the surface of the solder article having metal brightness;
Δ: the surface of the solder article exhibiting yellowish color; and
×: the surface of the solder article exhibiting yellow, blue, purple, or relatively dark colors.

3. The bonding strength was determined using zone shear bond test to detect a brittle fracture degree of a solder bump. The solder composition was reflowed with the copper pad, and a joint between a solder bump formed from the solder composition and the copper pad was then destroyed using a high speed bondtester. The bonding strength was evaluated according to a standard as follows:
◯: brittle fracture ratio<10%;
Δ: 10%≦brittle fracture ratio<15%; and
×: brittle fracture ratio≧15%.

TABLE 1
(Difference in Ag content)

| | Component (wt %) | | | | | |
|---|---|---|---|---|---|---|
| | the balance being Sn | | | | | Tensile |
| | Cu | Bi | Ag | Ni | Ge | strength |
| Example 1 | 0.5 | 3.0 | 3.0 | 0.06 | 0.005 | ◯ |
| Example 2 | 0.5 | 3.0 | 4.0 | 0.06 | 0.005 | ◯ |
| Example 3 | 0.5 | 3.0 | 5.0 | 0.06 | 0.005 | ◯ |
| Comparative | 0.5 | 3.0 | 0 | 0.06 | 0.005 | Δ |
| Example 1 | | | | | | |
| Comparative | 0.5 | 3.0 | 6.0 | 0.06 | 0.005 | The melting |
| Example 2 | | | | | | point was too |
| | | | | | | high |

Referring to Table 1, the results for Examples 1 to 3 show that, when Ag content of the solder composition ranges from 3 wt % to 5 wt %, the solder composition exhibits superior tensile strength. As shown in Comparative Example 1, when the solder composition contains no Ag, the tensile strength of the solder composition is too weak and is unsuitable for soldering. Comparative Example 2 shows that, when the solder composition contains 6 wt % of Ag, the melting point of the solder composition is too high and is unsuitable for use in the WLP process.

TABLE 2
(Difference in Cu content)

| | Component (wt %) | | | | | |
|---|---|---|---|---|---|---|
| | the balance being Sn | | | | | Tensile |
| | Cu | Bi | Ag | Ni | Ge | strength |
| Example 4 | 0.2 | 3.0 | 4.0 | 0.06 | 0.005 | ◯ |
| Example 5 | 0.5 | 3.0 | 4.0 | 0.06 | 0.005 | ◯ |
| Example 6 | 0.8 | 3.0 | 4.0 | 0.06 | 0.005 | ◯ |
| Comparative | 0 | 3.0 | 4.0 | 0.06 | 0.005 | Δ |
| Example 3 | | | | | | |
| Comparative | 1.0 | 3.0 | 4.0 | 0.06 | 0.005 | The melting |
| Example 4 | | | | | | point was too |
| | | | | | | high |

Referring to Table 2, the results for Examples 4 to 6 show that, when Cu content of the solder composition ranges from 0.2 wt % to 0.8 wt %, the solder composition exhibits superior tensile strength. As shown in Comparative Example 3, when the solder composition contains no Cu, the tensile strength of the solder composition is too weak and is unsuitable for soldering. Comparative Example 4 shows that, when the solder composition contains 1 wt % of Cu, the melting point of the solder composition is too high and is unsuitable for use in the WLP process.

TABLE 3
(Difference in Bi content)

| | | | | | | Tensile |
|---|---|---|---|---|---|---|
| | | | | | | strength |
| | Component (wt %) | | | | | after |
| | the balance being Sn | | | | | thermal |
| | Cu | Bi | Ag | Ni | Ge | treatment |
| Example 7 | 0.5 | 1.0 | 4.0 | 0.06 | 0.005 | ◯ |
| Example 8 | 0.5 | 3.0 | 4.0 | 0.06 | 0.005 | ◯ |
| Example 9 | 0.5 | 7.0 | 4.0 | 0.06 | 0.005 | ◯ |
| Comparative | 0.5 | 0 | 4.0 | 0.06 | 0.005 | X |
| Example 5 | | | | | | |
| Comparative | 0.5 | 9.0 | 4.0 | 0.06 | 0.005 | X |
| Example 6 | | | | | | |

Referring to Table 3, the results for Examples 7 to 9 show that, when Bi content of the solder composition ranges from 1 wt % to 7 wt %, the solder composition exhibits superior tensile strength after being exposed to 150° C. for 7 days. As shown in Comparative Example 5, when the solder composition contains no Bi, the solder composition exhibits inferior tensile strength after thermal treatment. Comparative Example 6 shows that, when the solder composition contains 9 wt % of Bi, the excess Bi content decreases the toughness of the solder composition and increases brittleness. Hence, the solder composition exhibits inferior tensile strength in Comparative Example 6.

TABLE 4
(Difference in Ge content)

| | | | | | | | Anti- | |
|---|---|---|---|---|---|---|---|---|
| | Component (wt %) | | | | | | oxi- | Bond- |
| | the balance being Sn | | | | | Tensile | dative | ing |
| | Cu | Bi | Ag | Ni | Ge | strength | activity | strength |
| Example 10 | 0.5 | 3.0 | 4.0 | 0.06 | 0.005 | ◯ | ◯ | ◯ |
| Example 11 | 0.5 | 3.0 | 4.0 | 0.06 | 0.020 | ◯ | ◯ | ◯ |
| Comparative | 0.5 | 3.0 | 4.0 | 0.06 | 0 | Δ | X | Δ |
| Example 7 | | | | | | | | |
| Comparative | 0.5 | 3.0 | 4.0 | 0.06 | 0.030 | X | ◯ | X |
| Example 8 | | | | | | | | |

Referring to Table 4, the results for Examples 10 and 11 show that, when Ge content of the solder composition ranges from 0.005 wt % to 0.02 wt %, the solder composition exhibits superior tensile strength, anti-oxidative activity, and bonding strength. The Ge metal could form an anti-oxidative layer on the surface of the solder article so as to isolate environmental oxygen and improve anti-oxidative activity of the solder composition. As shown in Comparative Example 7, when the solder composition contains no Ge, it exhibits inferior anti-oxidative activity so that the solder composition is easy to be oxidized and the bonding strength becomes weak. Comparative Example 8 shows that, when the solder composition contains 0.03 wt % of Ge, it has superior anti-oxidative activity. However, the excess Ge content causes high brittleness and low tensile strength and bonding strength.

TABLE 5
(Difference in Ni content)

| | Component (wt %) | | | | | |
|---|---|---|---|---|---|---|
| | the balance being Sn | | | | | Bonding |
| | Cu | Bi | Ag | Ni | Ge | strength |
| Example 12 | 0.5 | 3.0 | 4.0 | 0.005 | 0.005 | ◯ |
| Example 13 | 0.5 | 3.0 | 4.0 | 0.06 | 0.005 | ◯ |
| Comparative | 0.5 | 3.0 | 4.0 | 0 | 0.005 | Δ |
| Example 9 | | | | | | |
| Comparative | 0.5 | 3.0 | 4.0 | 0.10 | 0.005 | X |
| Example 10 | | | | | | |

Referring to Table 5, the results for Examples 12 and 13 show that, when Ni content of the solder composition ranges from 0.005 wt % to 0.06 wt %, the solder composition exhibits superior bonding strength. As shown in Comparative Example 9, when the solder composition contains no Ni, the bonding strength is inferior which might be attributed to the generation of the brittle Cu₃Sn intermetallic layer between the solder bump and the pad. Comparative Example 10 shows that, when the solder composition contains 0.1 wt % of Ni, the tensile strength and bonding strength are adversely affected. This might be due to the uneven dispersion of the excess Ni in the solder composition and the precipitation of Ni caused by oversaturation.

In this invention, with addition of Cu, Bi, Ag, Ni, and Ge to Sn, the lead-free solder composition has excellent anti-oxidative activity, bonding strength, and tensile strength even after exposing the lead-free solder composition to a high temperature for a long period of time.

While the present invention has been described in connection with what are considered the most practical and the preferred embodiments, it is understood that this invention is not limited to the disclosed embodiments but is intended to cover various arrangements included within the spirit and scope of the broadest interpretation and equivalent arrangements.

What is claimed is:

1. A lead-free solder composition, comprising: 3 wt % to 5 wt % of Ag, 0.2 wt % to 0.8 wt % of Cu, 1 wt % to 7 wt % of Bi, 0.005 wt % to 0.06 wt % of Ni, 0.005 wt % to 0.02 wt % of Ge, and the balance being Sn based on 100 wt % of said lead-free solder composition.

2. The lead-free solder composition as claimed in claim 1, which is used in wafer-level packaging.
